(19) United States
(12) Patent Application Publication
(10) Pub. No.: US 2004/0114594 A1
(43) Pub. Date: Jun. 17, 2004

(54) Method for setting up a fax connection over a packet-oriented network

(75) Inventor: Holger Hoffmann, Schwerte (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft of Munich, Germany

(21) Appl. No.: 10/657,716

(22) Filed: Sep. 9, 2003

(30) Foreign Application Priority Data
Sep. 9, 2002 (DE) 10241707.5

(51) Int. Cl. H04L 12/56

(52) U.S. Cl. 370/389; 370/401

(57) ABSTRACT

A method sets up a fax connection between a calling first fax machine controlled by a first communication facility and a called second fax machine controlled by a second communication facility over a packet-oriented network linking the communication facilities. With this method, sent data of the first or second fax machine is terminated at a first data gateway belonging to the first communication facility or at a second data gateway belonging to second communication facility. Following setup of a useful data connection between the first and second data gateway, a transmission-controlling connection is set up between the first fax machine and the first data gateway. Identification information of the sending first fax machine is then transmitted from the first data gateway to the second data gateway. A transmission-controlling connection is then set up between the second fax machine and the second data gateway. The transmission-controlling connection between the second fax machine and the second data gateway is set up before the identification information is transmitted.

### CROSS REFERENCE TO RELATED APPLICATIONS

This application is based on and hereby claims priority to German Application No. 10241707.5 filed on Sep. 9, 2002, the contents of which are hereby incorporated by reference.

### BACKGROUND OF THE INVENTION

The invention relates to a method for setting up a fax connection over a packet-oriented network.

Modern communication systems are increasingly based on packet-oriented communication connections as an expansion of or replacement for customary connection- or timeslot-oriented communication connections.

Ongoing expansion of packet-oriented networks, such as the internet or spatially limited networks, frequently referred to in specialist parlance as a ‘Local Area Network (LAN)’, in many cases makes possible a version of a telecommunications infrastructure that is more economical than a connection-oriented communication network. Communication networks based on a packet-oriented technology, frequently referred to in specialist parlance as ‘Voice-over-IP, VoIP’, in many cases build on the protocols that are known to specialists for data communication over the internet, in particular what is called the ‘Internet Protocol’, abbreviated to ‘IP’. Widespread use is made for VoIP communication of the H.323 ITU-T (International Telecommunication Union—Telecommunications Standardization Sector) standard or the SIP (Session Initiation Protocol) developed by the IETF (Internet Engineering Task Force) Working Group.

In contrast to communication networks employing timeslot-oriented technology, in communication networks that use a packet-oriented technology the switching of communication partners is not administered by a central communication facility. Instead, the communication connection is maintained by the reciprocal sending and receiving between the two communication partners of data packets containing useful and signaling information, with the individual data packets including information about the respective other communication partner's destination address.

Some communication systems support both timeslot-oriented and packet-oriented technology so that both classical and VoIP communication terminals can be linked over a packet-oriented network.

System units, referred to in specialist parlance also as ‘network units’, are employed for controlling a connection setup and for general handling of a telecommunication connection, referred to also as ‘call processing’, between two VoIP communication terminals.

So-called gateways that are controlled by the network unit are provided for determining the routing through the packet-oriented network. There are both gateways for determining the routing of data packets containing signaling data and gateways for determining the routing of data packets containing useful data, hence in particular voice, video or remote copy data. Gateways of this type convert data streams into suitable data packets. Digital signal processors, for example, are provided for converting useful data into digital information.

Specific consideration is given below to setting up a remote copy data connection—fax transmission—for example according to the ITU-T standard T.30, over a packet-oriented network, where problems arise in connection with the related art in setting up and initializing the remote copy data transmission.

The related art is first presented with the aid of the drawing in FIG. 3.

FIG. 3 shows two communication facilities PBX1;PBX2 connected via a packet-oriented network LAN. A first fax machine FG1 is connected to the first communication facility PBX1 and a second fax machine FG2 is connected to the second communication facility PBX2.

The figurative designation ‘fax machine’ also includes software applications which communicate with a respective communication system or partner in a manner that is similar to a fax machine.

Several system units are located in the first communication facility PBX1 of which a first network unit NU1, a first data gateway DG1, and a first fax protocol unit FX1 are shown. A second network unit NU2, a second data gateway DG2, and a second fax protocol unit FX2 are shown in a corresponding manner in the second communication facility PBX2.

It is assumed below that an outgoing connection request to a second fax machine FG2 assigned to the second communication facility PBX2 arises through the first fax machine FG1 assigned to the first communication facility PBX1. The remote copy data and associated signaling and control messages are transmitted over the packet-oriented network LAN between the two communication facilities PBX1,PBX2 in the form of data packets.

When a connection setup is initiated, the network unit NU1 responsible for controlling the connection setup communicates with the first data gateway DG1 in order to request the release of resources. When these resources have been released, messages or data of the fax machine FG1 are essentially extended transparently from the network unit NU1 to the first data gateway. The same applies analogously in the opposite direction. The first data gateway DG1 must accordingly be viewed as the respective end point of a communication relationship with the first fax machine FG1 or with the—otherwise analogously embodied—second data gateway DG2.

A signaling channel is set up between the first and second data gateway DG1,DG2 in a first phase and a useful data channel is set up between the gateways in a subsequent phase.

With use being made of the first fax protocol unit FX1, signals are exchanged by the first data gateway with the first fax machine FG1 or with the second data gateway DG2 in an existing useful data channel according to a fax protocol, such as the ITU-T standard T.30. The respective fax protocol units FX1,FX2 are not needed for setting up the signaling channel, the useful data channel or, finally, for exchanging image information of the fax transmission. At the first or second data gateway DG1,DG2, data is extended in these cases without forwarding to the relevant assigned fax protocol unit FX1,FX2.

The related art is presented below with further reference to the system units shown in FIG. 3 with the aid of FIG. 2A and FIG. 2B.

FIGS. 2A and 2B show an exchange of control messages between the system units of the first communication facility PBX1 over the packet-oriented network LAN with system units of the second communication facility PBX2. It is assumed that an outgoing connection request to the second fax machine FG2 arises through the first fax machine FG1. The remote copy data and associated signaling and control messages are transmitted over the packet-oriented network LAN between the two communication facilities PBX1,PBX2 in the form of data packets.

Control messages exchanged between the system units, mostly in the form of request messages (‘request’) or confirmation messages (‘confirm’), are triggered as a function of specific actions that either have been or which are to be carried out or events that have occurred in the system units.

A line shown in dash-dot form in the drawing separates in each case the system units, shown on the left in the drawing, of the first communication facility PBX1, which is to say the first network device NU1, the first data gateway DG1, and the first fax protocol unit FX1, from system units, shown on the right in the drawing, of the second communication facility PBX2, which is to say the second network device NU2, the second data gateway DG2, and the second fax protocol unit FX2.

Time beams 1,2,3,4,5,6 are assigned in this order to the first network unit NU1, the first data gateway DG1, the first fax interface FX1, the second fax interface FX2, the second data gateway DG2, and the second network unit NU2. Time beams 1,2,3,4,5,6 run from top to bottom, so that later times are lower than earlier times.

Control messages are explained below in chronological order, together with events occurring or with actions, with the aid of the drawing.

On the basis of a connection request—which arrived prior to the time t0—of the first fax machine FG1, at the time t0 the first network unit NU1 generates a request message 110 which is referred to also as a ‘GW_ALLOC_CHANNEL_REQ’ message (‘request’). This message 110 is transmitted to the first data gateway DG1 in order to request provisioning of resources of the first data gateway DG1 for the data connection that is to be set up to the second fax machine FG2.

At the time ti the first data gateway DG1 then sends a request message 112 to the second data gateway DG2 which is referred to also as a ‘DGW_ALLOC_REQ’ message. This request message 112 serves to request resources of the second data gateway DG2 for the data connection that is to be set up.

At the time t2 the second data gateway DG2 sends an advisory message 114 which indicates successful provisioning of resources of the second data gateway DG2 to the controlling second network unit NU2 and which is referred to also as an ‘NU_MSG_ALLOC_CHN_IND’ message (‘indication’). When this message has arrived, the second network unit NU2 initiates a ‘SETUP’ instruction (not shown) to the second fax machine FG2. If the second fax machine FG2 is not busy it will acknowledge with an ‘ALERT’ message (not shown) which is transmitted to the controlling network unit NU2 in conjunction with signaling or ringing of a user.

At the time t3 the second network unit NU2 then generates a request message 116 which is referred to also as an ‘ALLOC_CHN_REQ’ message. This message 116 is transmitted to the second data gateway DG2 in order to request provisioning of resources of the second data gateway DG2 for the data connection that is to be set up to the first fax machine FG1. At the time t4, after resources have been provided, the second data gateway DG2 sends a confirmation message 118 to the first data gateway DG1 which is referred to also as a ‘DGW_ALLOC_CONF’ message (‘confirm’). This confirmation message 118 serves to notify the first data gateway DG1 that provisioning of resources of the second data gateway DG2 has been carried out in response to the request message 112.

At the time t5 the first data gateway DG1 sends a confirmation message 120 to the first network unit NU1 which is referred to also as ‘DG1 ALLOC_CONF’ and which serves to provide the first network unit NU1 with confirmation of the request message 110.

At the time t5, the connection setup at the level of a signaling channel between the two fax machines FG1,FG2 has been concluded. The setting up of a useful data connection takes place in the following at the level of the system units, which is to say the first network device NU1, the first data gateway DG1 of the first fax protocol unit FX1 of the second network device NU2, the second data gateway DG2, and the second fax protocol unit FX2.

At the time t6 the first network unit NU1 generates a request message 122 which is referred to also as a ‘GW_OPEN_CHANNEL_REQ’ message. This message 122 is transmitted to the first data gateway DG1 in order to request opening of a useful data channel by the first data gateway DG1.

At the time t7 the first data gateway DG1 generates a request message 124 which is referred to also as a ‘CONNECT_B3_REQ’ message 124. This message 124 is transmitted to the first fax protocol unit FX1 in order to request opening of a useful data channel for the waiting remote copy data transmission by the first fax protocol unit FX1.

At the time t8 the first fax protocol unit FX1 sends a confirmation message 126 to the first data gateway DG1 which is referred to also as ‘CONNECT_B3_CONF’ and which serves to provide the first data gateway DG1 with confirmation of the request message 110.

The two messages 124,126 sent at the time t7 or at the time t8 are transmitted, for example, via an intermediately connected CAPI (Common Application Programming Interface) protocol unit (not shown). The known interface CAPI is a software or communication interface which is located above the call-processing layer and which makes the communication protocols available for the useful data channel. Messages between the first or second data gateway DG1,DG2 and the first or second fax protocol unit FX1,FX2 explained below are transmitted, for example, via this CAPI interface with no reference being made to this intermediate layer in the remaining description.

At the time t9 the first data gateway DG1 sends a confirmation message 128 to the second data gateway DG2 which is referred to also as ‘DGW_OPEN_CONF’ and which reports successful initializing for setting up the useful data channel to the second data gateway DG2.

Upon arrival of a ‘CONNECT’ message (not shown) which is sent from the second fax machine FG2 to the second network unit NU2 and which clearly reports ‘going off-hook’ of the second fax machine FG2, which is to say acceptance of the connection request initiated by the first fax machine FG1, a connection has been set up between the second fax machine FG2 and the second network unit NU2 at a time (not shown) that is earlier than the time t10. According to the ITU-T standard T.30, after a definable period of time a sending of so-called CED (Called Terminal Identification) signals takes place on the second fax machine FG2. CED signals are sent by a communication terminal not operating on a voice basis on the useful data channel in order to indicate that this called communication terminal—in this case: the second fax machine FG2—is in the transmission mode. The period of time that elapses between ‘going off-hook’ of the second fax machine FG2 and sending of the CED signals is set to approximately seven seconds because the following procedural steps require roughly that length of time before the first fax machine FG1, in its turn, changes over to the transmission mode. The CED signal is therefore not transmitted in a manner that can be synchronized using a control message.

At the time t10 the second network unit NU2 generates a request message 130 which is referred to also as a ‘GW_OPEN_CHANNEL_REQ’ message 130. This message 130 is transmitted to the second data gateway DG2 in order to request initializing for setting up the useful data channel on the part of the second data gateway DG2.

For initializing for the purpose of setting up the useful data channel on the part of the second data gateway DG2, the second data gateway DG2 sends a request message (not shown) to the CAPI protocol unit (not shown) assigned to the second data gateway DG2 in order to request resources from this CAPI protocol unit. When resources are released by the CAPI protocol unit, a confirmation message (not shown) is transmitted by the CAPI protocol unit to the second data gateway DG2.

At a succeeding time t11, the second data gateway DG2 sends a confirmation message 132 to the second network unit NU2 which is referred to also as ‘NU_MSG_OPEN_CHN_CONF’ and which serves to provide the second network unit NU2 with confirmation of the request message request message 130.

At the time t12 the second data gateway DG2 sends a confirmation message 134 to the first data gateway DG1 which is referred to also as ‘DGW_OPEN_CONF’ and which reports successful initializing for setting up the useful data channel to the first data gateway DG1.

At the time t13 the first data gateway DG1 sends a confirmation message 136 to the first network unit NU1 which is referred to also as ‘NU_MSG_OPEN_CHN_CONF’ and which serves to provide the first network unit NU1 with confirmation of the request message request message 122.

As of the time t13 the useful data channel has been set up for the fax connection under consideration. At the succeeding times t14,t15,t16 described below a connection setup takes place between the fax machines FG1,FG2 at the level of an exchange of useful data with arrangements on initiating the data connection between the fax machines FG1,FG2 taking place prior to transmission of the actual image data of the remote copy that is to be executed. The first fax machine FG1 changes over to the transmission mode by transmitting so-called CNG signals (‘calling tone’).

The two data gateways DG1,DG2 then act on their part like fax machines, which is to say the first data gateway DG1 communicates both with the first fax machine FG1 and with the second data gateway DG2 at the level of a fax protocol. The second data gateway DG2 in turn communicates in the same way with the second fax machine FG2 and with the first data gateway DG1. In this way the fax data transmission takes place at a later time (not shown) from the first fax machine FG1 to the first data gateway DG1, from where the fax data is transmitted to the second data gateway DG2 over the packet-oriented network LAN and, finally, to the second fax machine FG2. The two data gateways DG1,DG2 carry out a respective conversion between continuous data streams and data packets.

At the time t14 the first fax protocol unit FX1 sends an advisory message 138 to the first data gateway DG1 which is referred to also as ‘CONNECT_B3_IND’ and which indicates successful initializing of the sender-side arrangements for initiating data connection to the first data gateway DG1.

At the time t15 the first data gateway DG1 generates a confirmation message 140 which is referred to also as a ‘CONNECT_B3_RESP’ message (‘response’). This message 140 is transmitted to the first fax protocol unit FX1.

At the time t16 the first fax protocol unit FX1 sends an advisory message 142 to the first data gateway DG1 which is referred to also as a ‘CON_B3_ACT_IND’ message and which transmits identification information for the arrangements to the first data gateway DG1. This identification information, also known as TSI, Transmitting Subscriber Identification, comprises, for example, an ID or directory number (‘station ID’) identifying the first fax machine FG1 and details of the type of fax etc.

The first data gateway DG1 transmits this identification information at the time t17 in the form of an advisory message 144 to the second data gateway DG2 which is referred to also as a ‘CONNECT_B3_ACT_IND’ message. This advisory message 144 serves to transmit the identification information to the second data gateway DG2.

When the identification information has been sent to the second data gateway DG2 with the advisory message 144, at the time t18 the first data gateway DG1 generates a confirmation message 146 which is referred to also as a ‘CON_B3_ACT_RESP’ message. This message 146 is transmitted to the first fax protocol unit FX1 in order to acknowledge the arrival of the advisory message 142 that took place at the time t16.

At the time t19 the second data gateway DG2 generates a request message 148 which is referred to also as a ‘CONNECT_B3_REQ’ message 148. This message 148 is transmitted to the second fax protocol unit FX2 in order to request opening of a useful data channel for the waiting remote copy data transmission by the second fax protocol unit FX2.

At the time t20 the second fax protocol unit FX2 sends a confirmation message 150 to the second data gateway DG2 which is referred to also as ‘CONNECT_B3_CONF’ and which serves to provide the second data gateway DG2 with confirmation of the preceding request message 148.

At the time t21 the second fax protocol unit FX2 sends an advisory message 152 to the second data gateway DG2 which is referred to also as ‘CONNECT_B3_IND’ and which indicates successful initializing of the recipient-side arrangements for initiating data connection to the second data gateway DG2.

At the time t22 the second data gateway DG2 generates a confirmation message 154 which is referred to also as a ‘CONNECT_B3_RESP’ message (‘response’). This message 154 is transmitted to the first fax protocol unit FX1.

Setting up of the fax connection is followed at the level of an exchange of useful information between the two fax machines FG1,FG2 by further steps such as transmitting configuration data and a training sequence for verifying the correct transmission of data between fax machines before actual transmission of the image data commences. These steps will not be considered further.

The flow of procedures described can be summarized as follows: Conclusion at the time t5 of a connection setup at a signaling level is followed by “going off-hook” of the receiving second fax machine FG2. Not until setting up of a connection between the first data gateway DG1 and the first fax machine FG1 has been fully concluded at the time t16 is a start made in the second communication facility PBX2 on setting up the connection between the second fax machine FG2 and the second data gateway DG2—initiated by arrival of the advisory message 144 at the second data gateway. However, the second fax machine FG2 has already ‘gone off-hook’ at this time and sent a CED signal, and is in the process of sending its configuration data. At the time when the second data gateway DG2—acting, according to the above embodiments, as a fax machine—sends its initializing data, namely the CNG signal, arrangements required according to the T.30 standard for the fax connection setup that is to be established are consequently superimposed because the recipient fax has already sent the CED signal at this time and begun sending its configuration data. This superimposing cannot be prevented by the mentioned 7-second delay of the CED signal following ‘going off-hook’ because the arrival time of the CNG message cannot be specified on a defined basis.

### SUMMARY OF THE INVENTION

One possible object of the invention is to eliminate the above problems.

According to one aspect of the invention, when a fax connection is established between a calling first fax machine and a called second fax machine, there is a fax connection setup with setting up of a transmission-controlling connection between a second fax protocol unit and a second data gateway before a control message containing identification information of the sending first fax machine FG1 is transmitted from a first data gateway to the second data gateway.

A major advantage of the method is that superimposing of initializing data of the sending first fax machine with initializing data of the receiving second fax machine is prevented.

The application of the described method advantageously produces a substantially faster fax connection setup because there is no need to implement a delay on system units of the receiving communication facility.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIGS. 1A and 1B show a chronological flow diagram schematically representing control messages exchanged in connection with setting up a fax transmission.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

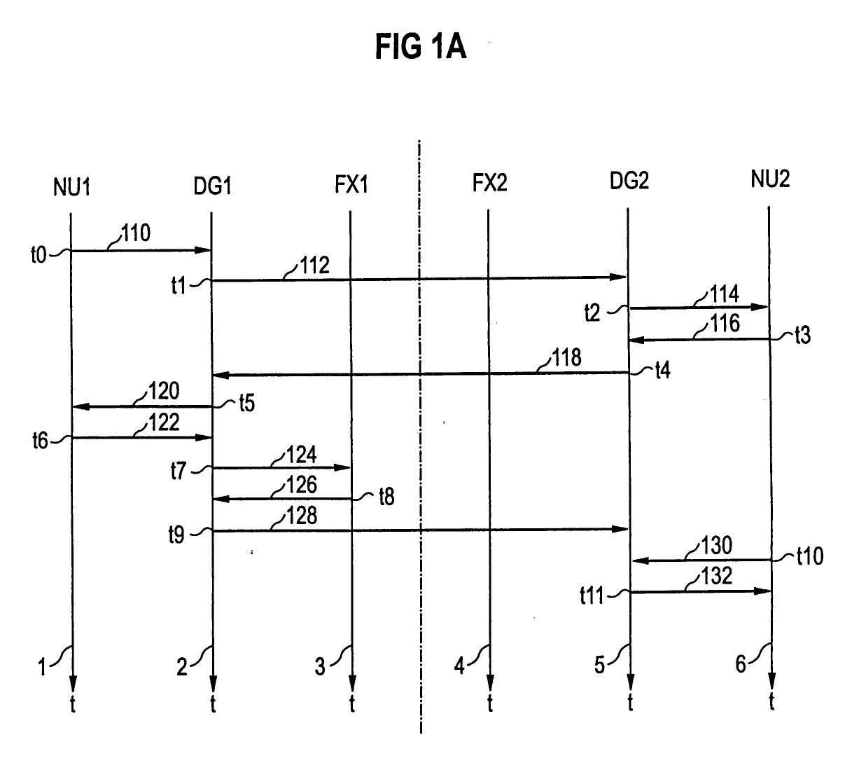

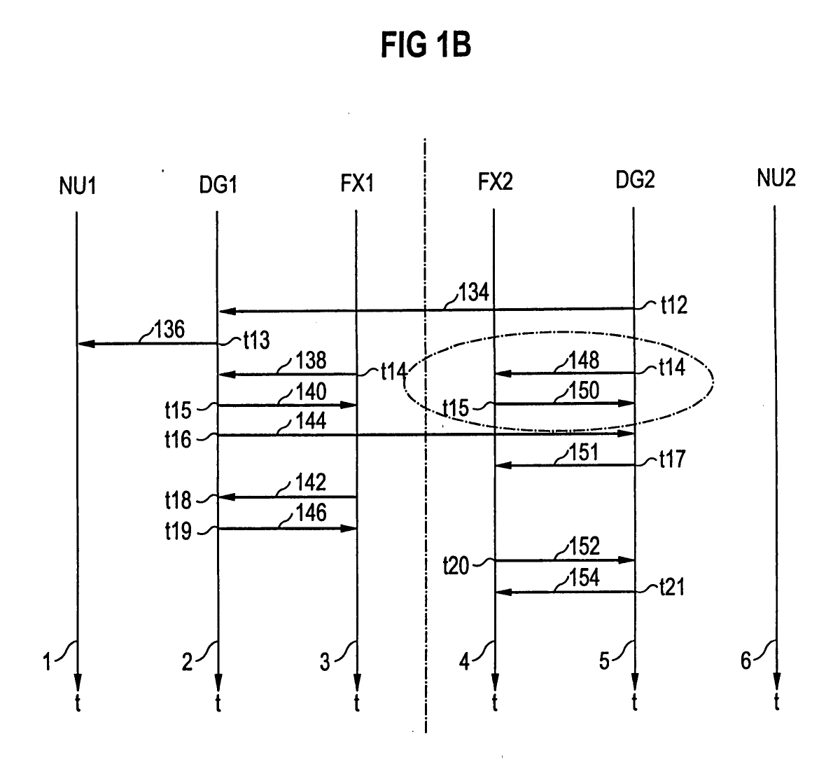

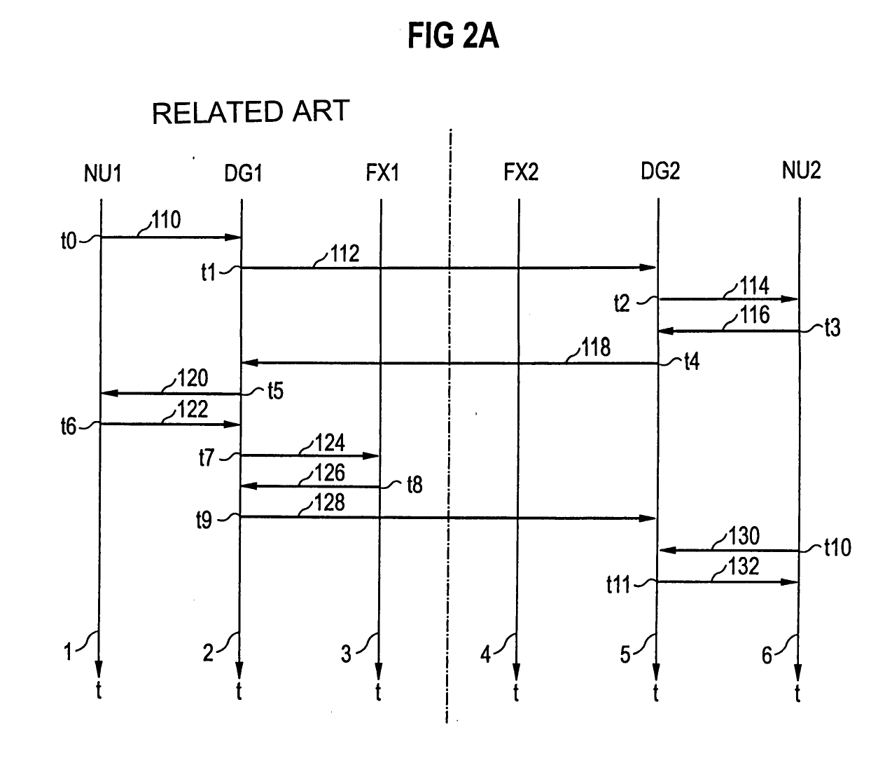

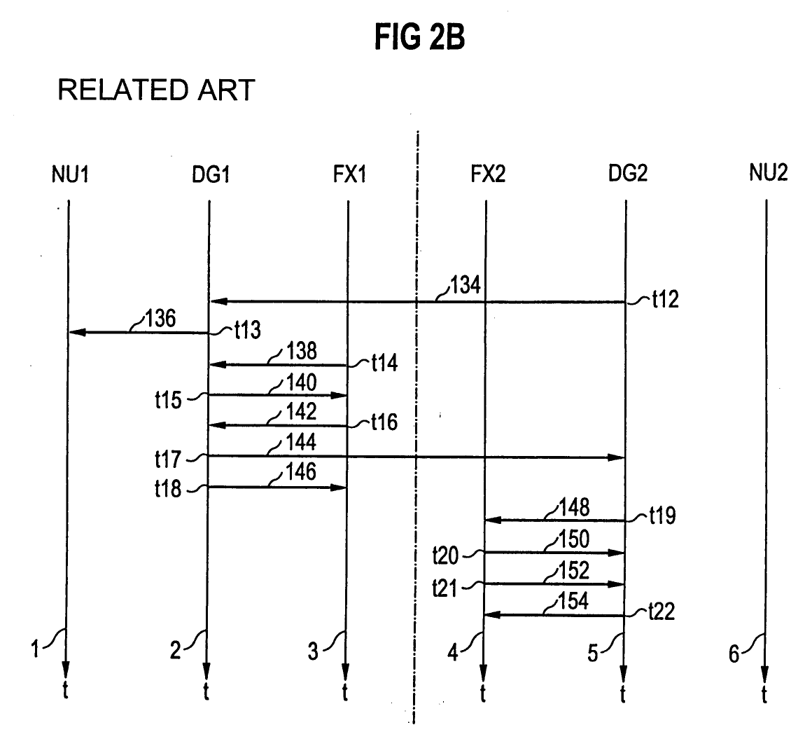

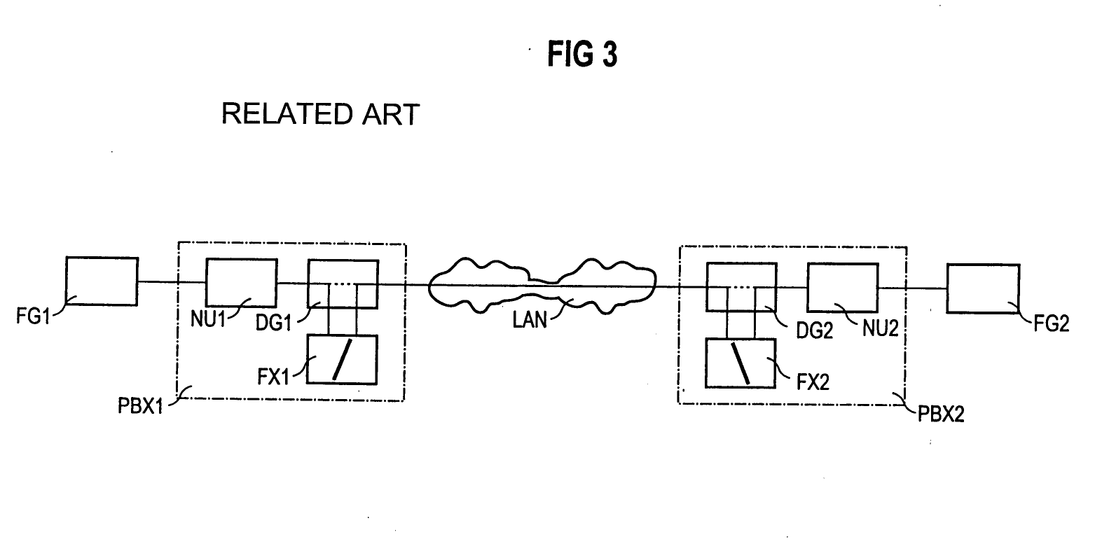

FIG. 1A shows an exchange of control messages 110 . . . 132, identical to FIG. 2A, between the times t0 . . . t11. Refer to the introduction to the description for details of the meaning of the control messages and time flow.

FIG. 1B shows the confirmation message 134, known from the related art, which reports successful initializing for setting up the useful data channel to the first data gateway DG1.

At the time t13 the first data gateway DG1 sends a confirmation message 136 to the first network unit NU1 serving to give the first network unit NU1 confirmation of the request message 122.

The method is explained below according to a preferred embodiment with the aid of exchanged control messages.

When the useful data channel for the fax connection under consideration has been set up at the time t13, a connection is set up between data gateways DG1,DG2 at the level of an exchange of useful data with arrangements on initiating the data connection between the fax machines FG1,FG2 taking place prior to transmission of the actual image data of the remote copy that is to be executed. In contrast to FIG. 2B, starting at the time t14 there is initializing of the arrangements on initiating the data connection on both the sender side by the control messages t14,t15 and on the recipient side—see dash-dot highlighting in the drawing—by the control messages 148,150. The control messages 148,150 previously transmitted at an earlier time—see FIG. 2B—are instead exchanged roughly synchronously with the control messages 138,140. In the interest of a clearer arrangement, this approximate synchronicity is shown in the drawing using exact synchronicity, so the control messages are shown at the times t14,t15.

In other respects the setup of control messages corresponds in FIGS. 2A or 2B to the respective control messages with identical reference numbers in FIGS. 1A or 1B.

At the time t14 the first data gateway DG1 transmits the identification information received from the first fax machine FG1 with the advisory message 138 at the time t16 in the form of the advisory message 144 to the second data gateway DG2. This advisory message 144 serves to transmit the identification information to the second data gateway DG2.

Because the initializing phase for setting up the fax data connection—see the prioritized control messages 148,150—has already been concluded at this time t16, a new control message 151 is necessary which is referred to also as “API_TSI”. At the time t17 this control message 151 transmits the identification information subsequently, optionally transmitted via the CAPI interface as an application programming interface (API) to the second fax machine FG2.

At the time t18 the first fax protocol unit FX1 sends the advisory message 142 to the first data gateway DG1 which is referred to also as a ‘CON_B3_ACT_IND’ message. In contrast to the advisory message 142 according to the related art according to FIG. 2B, this message does not necessarily contain identification information of the first fax machine FG1, which has already been transmitted by the control message 138 from the first fax protocol unit FX1 to the first data gateway.

At the time t19 the first data gateway DG1 generates the confirmation message 146. This message 146 is transmitted to the first fax protocol unit FX1 in order to acknowledge arrival of the advisory message 142 at the time t18.

At the time t20 the second fax protocol unit FX2 sends the advisory message 152 to the second data gateway DG2, which indicates successful initializing of the recipient-side arrangements for initiating data connection to the second data gateway DG2.

At the time t21, the second data gateway DG2 generates the confirmation message 154 which is transmitted to the first fax protocol unit FX1.

The invention has been described in detail with particular reference to preferred embodiments thereof and examples, but it will be understood that variations and modifications can be effected within the spirit and scope of the invention.

What is claimed is:

1. A method for setting up a fax connection between a calling fax machine controlled by a first communication facility and a called fax machine controlled by a second communication facility over a packet-oriented network connecting the communication facilities, comprising:
terminating sent data of the first fax machine at a first data gateway belonging to the first communication facility;
terminating sent data of the second fax machine at a second data gateway belonging to the second communication facility;
setting up a useful data connection between the first and second data gateways;
setting up a transmission-controlling connection between the first fax machine and the first data gateway;
setting up a transmission-controlling connection between the second fax machine and the second data gateway; and
after setting up the transmission-controlling connection between the second fax machine and the second gateway, transmitting identification information of the sending fax machine from the first data gateway to the second data gateway.

2. The method according to claim 1, wherein the transmission-controlling connection between the second fax machine and second data gateway is set up synchronously with the transmission-controlling connection between the first fax machine and the first data gateway.

3. The method according to claim 1, wherein the identification information identifies the type of fax machine.

4. The method according to claim 1, wherein the identification information contains information about a directory number identifying the fax machine.

5. The method according to claim 1, wherein at least one of the first and second data gateways employs a fax protocol unit for converting connection-controlling useful data.

6. The method according to claim 1, wherein both the first and second data gateways employ a fax protocol unit for converting connection-controlling useful data.

7. The method according to claim 6, wherein
control messages are exchanged between the fax protocol units and the data gateways, and
the control messages are received and sent by an intermediately connected application interface.

8. The method according to claim 7, wherein the application interface is embodied according to the CAPI standard.

9. The method according to claim 2, wherein the identification information identifies the type of fax machine.

10. The method according to claim 9, wherein the identification information contains information about a directory number identifying the fax machine.

11. The method according to claim 10, wherein the first and second data gateways employ a fax protocol unit for converting connection-controlling useful data.

12. The method according to claim 11, wherein both the first and second data gateways employ a fax protocol unit for converting connection-controlling useful data.

13. The method according to claim 12, wherein
control messages are exchanged between the fax protocol units and the data gateways, and
the control messages are received and sent by an intermediately connected application interface.
